(19) United States
(12) Patent Application Publication
(10) Pub. No.: US 2008/0320470 A1
(43) Pub. Date: Dec. 25, 2008

(54) Process for creating an automatically distributable software package

(75) Inventor: Richard Crowley, Wachtberg (DE)

Correspondence Address: THE NATH LAW GROUP, 112 South West Street, Alexandria, VA, 22314, US

(73) Assignee: CebiCon GmbH, Bonn (DE)

(21) Appl. No.: 12/213,471

(22) Filed: Jun. 19, 2008

(30) Foreign Application Priority Data
Jun. 20, 2007 (DE) 102007028807.9-53

(51) Int. Cl. G06F 9/445

(52) U.S. Cl. 717/177

(57) ABSTRACT

The invention relates to a process for creating an automatically distributable software package, as based on a standard software that is supplied to the computer. The process calls for a server that is connected to the computer over a communication network, such as the Internet, and involves the following steps:
automatic transmission to the computer of packaging data stored on the server, on the basis of the standard software designation and at least one installation parameter, and
automatic packaging of the standard software into an automatically distributable software package on the computer on the basis of the packaging data transmitted by the server.

For the customer who desires to automatically distribute a standard software to a number of computers in his firm, this process provides a simple and cost-effective means of creating an automatically distributable software package, without the need for scripting know-how.

The invention relates to a process for creating a software package which can be automatically distributed and which is based on standard software provided to a computer.

The installation of software onto computers for individual employees, particularly in businesses of large and moderate size, is not generally such that there is individual installation on site for each computer. Instead, the software to be installed is usually distributed in automatic fashion. In order to automatically distribute a software application, this software generally must be packaged, and thus transformed into a software package that can be automatically distributed. Only a very few software applications are offered by the manufacturer in this form, i.e., a form that permits automatic distribution and therefore renders packaging unnecessary. Packaging thus involves the preparation of software otherwise intended for individual, on-site installation by providing the software with additional, automatically available information, e.g. on different installation parameters, such as defaults, storage points, etc.

There are various standards for software packaging. A frequently employed standard comes from Microsoft®, the so-called Microsoft Installer® (MSI®). The corresponding packaging of the software may take place in entirely different ways: the packaging may be done by in-house IT employees of the given company, by service providers who create packages at the given company (on-site) or for the given businesses (off-site) and who charge by expense incurred, or finally by providers who create packages in a so-called package factory and sell them to their clients at a fixed price.

In any case, scripting know-how is always necessary in the creation of software packages that can be automatically distributed, i.e., scripting know-how is necessary for the actual packaging. For the companies in which the software is to be automatically distributed, this means those companies must use their own appropriately trained personnel or resort to expensive external service providers.

The goal of the invention, therefore, is to provide a process by means of which an automatically distributable software package can be created in a simple and cost-effective manner.

Proceeding from the initially described process, this problem is solved by a server connected to a computer over a communication network and by a process involving the following steps:
automatic transmission to the computer of packaging information stored on the server, on the basis of the standard software designation and at least one installation parameter, and
automatic packaging of the standard software into an automatically distributable software package on the computer, on the basis of packaging information transmitted from the server.

Standard software here is understood to be that kind of software that in the form provided is generally not just individually but commonly available. This means that the term “standard software” in general signifies commercial, but also freely available, programs which are installed in identical form and used by different users, though usually with different installation parameters. The designation standard software also signifies software that permits unambiguous identification of the software, generally through specification of the name and version.

In accordance with the invention, an automatic packaging of the standard software is provided in such a way that packaging data for different standard software installations is stored on the server and an automatically distributable software package is created from the standard software, as based on the standard software designation and at least one installation parameter, but usually a plurality of installation parameters. This package is then available on the computer and can be further distributed from that point, e.g., via a company LAN.

The result is a capability for acquiring an automatically distributable software package in a simple and cost-effective manner on the basis of a standard software, and specifically without scripting know-how. A firm using this process is therefore not required to have scripting know-how, and it is sufficient for the employee in charge of the software's automatic distribution to know the relevant installation parameters for the standard software being installed, so that he or she can communicate them to the system.

In principle, it is possible to provide the computer and/or the server with active data relating to one or more installation parameters. A preferred elaboration of the invention, however, provides for an automatic inquiry dialogue with the computer on the installation parameter(s). This ensures that the user does not forget the installation parameters, inasmuch as it is possible to make an inquiry about all relevant installation parameters.

In principle, the system can be actively provided with the designation of the standard software. A preferred elaboration of the invention, however, provides for the execution of an automatic inquiry for the designation of the standard software. A preferred alternative elaboration of the invention provides that the designation of standard software furnished to the computer is automatically recorded. If, in this connection, a preferred elaboration provides that the standard software is furnished on the computer itself—and preferably on a removable data medium such as a CD or DVD—then the removable medium can be accessed to record the designation of the standard software being installed. The same applies to the preferred elaboration of the invention in which the standard software is furnished online over the communication network.

Another particularly preferred elaboration of the invention provides that the standard software is furnished by the server itself The result is that a service is made available that not only takes over the automatic packaging of the software, but also makes it possible to purchase this software. In this way, the customer is provided with a single address at which he can order the software and also obtain it in a form that permits its automatic distribution.

In principle, different communication networks which connect the computer the server are conceivable, e.g., an in-house LAN. A preferred elaboration of the invention, however, provides that the communication network employed is the Internet. As a result, the service according to the invention can be provided anywhere in the world where there is Internet access, twenty-four hours a day, seven days a week.

In addition, it is possible to automatically transfer to the computer the packaging data stored on the server, as well as to automatically package the standard software into an automatically distributable software package at any desired place, including the server. In a preferred elaboration of the invention, however, it is provided that the automatic transfer to the computer of the packaging information stored on the server and/or the automatic packaging of the standard software into an automatically distributable software package on the computer is executed by a procedure running on the computer itself. This means that a locally operating “wizard” can be provided, which executes the actual packaging on the computer and to this end exchanges data with the server over the communication network. More specifically, the wizard makes available to the server data on the designation of the standard software to be installed, or the installation parameters, and then receives corresponding packaging data from the server.

Here it is fundamentally possible that the procedure—e.g., the wizard—can come to the computer in different ways, e.g., via a removable data medium such as a CD or DVD. In a preferred elaboration of the invention, however, it is provided that the process is made available by the server and ideally transmitted over the communication network. The result is a downloading capability by means of which the wizard can be transmitted to the computer. In particular, it is possible to provide for a wizard to be downloaded that is already adapted to the standard software being installed.

In principle, it is possible to perform a renewed automatic interrogation of all parameters for each new packaging of a standard software. In a preferred elaboration of the invention, however, it is provided that at least one installation parameter, and ideally all installation parameters, that have been used for a preceding software packaging are stored on the server. In this way, the user's task in the process is noticeably simplified if he must implement different standard software packagings on the basis of unchanged installation parameters.

As stated at the outset, there are different standard formats for automatically distributing software packages. In this connection, a preferred elaboration of the invention provides that the standard software is automatically packaged into an automatically distributable software package using a predetermined format. When a standard software is not available in this predetermined form, it is automatically converted into this format upon packaging. In this preferred elaboration of the invention, it can be provided that there is a fully automated re-packaging from an old setup process to a current standard, such as MSI®.

The invention will next be described in detail on the basis of a preferred exemplary embodiment and with reference to the drawing, which shows:

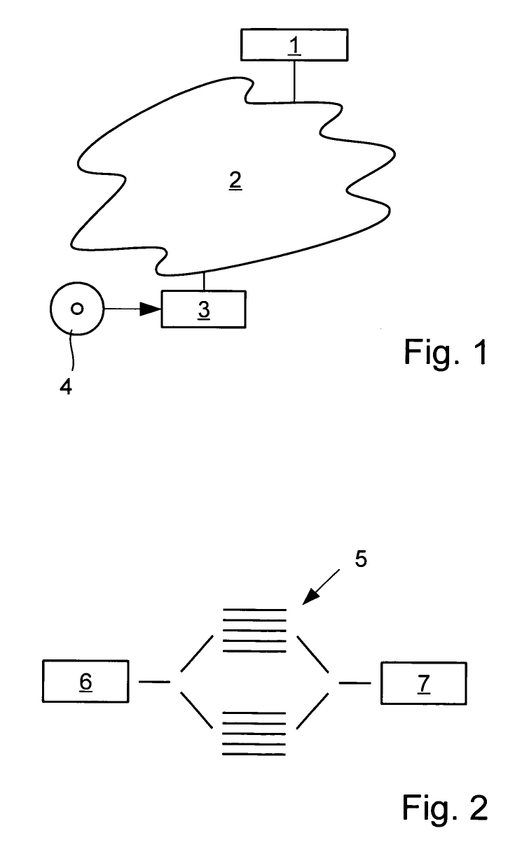

FIG. 1 schematic depiction of the process according to a preferred exemplary embodiment, provided through a web portal available via the Internet, and

FIG. 2 schematic depiction of re-packaging from an old setup process to a current standard.

To be able to provide the process that is next described in detail on the basis of the preferred exemplary embodiment, the provider must be able to analyze the standard software for which an automatically distributable software package is being created. In this analysis the preconditions for installation are examined and automatic tests are performed on quality and the observance of the rules of installation; if necessary, a set of rules are issued in order to convert old installation setups into current setups, e.g., MIS® setups. In addition, the configuration parameters for the installations are worked out, so that an automatically adapted packaging of the standard software can be performed through the interrogation of these parameters.

Thus, the appropriate packaging data is created for a given standard software, and this data depends not only on the designation of the standard software, but also on the desired installation parameters. This packaging data is stored on server 1, which is available through the Internet 2, specifically in the form of a web portal.

At this web portal the customer can select the standard software which he desires to make available in automated form at his company. In the process, he can use the web portal to inform himself on the software's details, such as dependencies, available parameters, etc., in order to purchase a corresponding module at the web portal. Then he will begin downloading the appropriate wizard, by means of which a process for the automatic packaging of the standard software will be made available on his computer 3, which is connected by Internet 2 to the server 1. After startup of the wizard, the customer will see a display showing the user name and password; next he will see the modules he has purchased. He will then select one of these modules to create a new configuration or will select an existing module in order to modify the configuration.

It is essential that only data for packaging, along with the downloadable wizard, can be made available over the web portal provided by the server 1. In the preferred exemplary embodiment now being described, the standard software to be automatically distributed to the customer at the given company is not made available over the server 1. Rather, it is present in the form of a removable data medium 4, such as an installation DVD, which is accessed by the computer 3 via a DVD drive (not described here in greater detail). This represents a very essential aspect of the exemplary embodiment of the invention now being described, inasmuch as its design removes any fear that the property rights of the provider and distributer of the standard software will be violated. This is to say, the customer uses the web portal only to allow the standard software legally available to be processed in a form that permits him to implement the automatic distribution of the software. In order for packaging to be realized, it is therefore unnecessary for the customer to pass on to a packaging service provider the standard software that he has acquired as a customer.

In the context of packaging, the wizard running locally on the computer will dynamically generate a suitable installation, e.g., an MSI® installation, when the selected module is being processed. The customer is guided by the local wizard and can perform the adjustments and configurations on the software in a simple manner, without the need for scripting know-how. The concrete technical implementation is performed by the wizard during the conversion process. Thus even those customers with no expert knowledge of scripting are able to create an automatically distributable software package of high quality in a very short period of time.

In this connection, it should be noted that the appropriate modules can be directly downloaded from the Internet on the basis of this design. Thus, without contractual agreements and without any infringement of the property rights of the manufacturer and provider of the standard software, it is possible to provide the customer with the opportunity to easily acquire automatic software installations in finalized form that can be converted and configured by non-specialists. In addition, the customer may acquire a voluminous information package on the software, which deals specifically with conflicts with other software products, analysis of infringements of the MSI® rules, etc.

Furthermore, a special property of the present process for creating an automatically distributable software package lies in the technique that is applied when the installation is not present in a predetermined format, such as the MSI®. Here the modules are used to automatically install the software on the customer's computer 3 (where the wizard happens to be running). In the process, the necessary data files and data are collected, and from these an entirely new installation is created, e.g., one based on the MSI® standard. This process, which is also called repackaging, is schematically depicted in FIG. 2, which shows how the repackaging process 5 provides an installation in a current standard format 7 using an old installation setup 6. The process proceeds in such a way that the part of the repackaging process 5 which extracts the data from the old installation setup 6 has been executed before the wizard begins to run. As a result, the wizard must access only the already “freed” data in order to use this data for the current standard format.

The modules that have been transferred over the Internet from the server 1 to the customer's computer 3 represent a kind of envelope within which all the data component parts are combined in the module, while the content in general is stored in an encoded form. This envelope can be provided with additional data, e.g., on licensing. Here the component parts are a scripting language which has access to all system resources, such as data files, registry, INI data files, etc. In addition, this scripting language includes special commands for processing and creating installation files.

Furthermore, a dialogue description language is included in order to simply and conveniently convert the specific configuration dialogues into different categories, such as setup, and standard and expert configuration, including, e.g., interconnections within the configurations. Also included are data and definitions that permit, e.g., the description of the customer's local setup files (version, medium, check sum, . . . ) and, if so desired, the URLs which indicate where the customer can download the software in a simple manner using the wizard, where the batches can be integrated, etc.

Naturally a decisive component is also represented by the definition of the steps necessary in converting the software, e.g., with regard to the question whether there is already an MSI® or whether the software has to be repackaged; whether batches are possible and whether they must be bundled; whether an expert configuration is available for this software, etc. Finally, a very essential component is the expertise that takes the form of definitions and scripts, by means of which the desired and completely automatic software installation can be created in accordance with specifications made by the customer.

1. Process for creating an automatically distributable software package as based on a standard software that is supplied to the computer (3), where a server (1) is connected to the computer (3) over a communication network (2), involving the following steps:
automatic transmission to the computer (1) of packaging data stored on the server (1), as based on the standard software designation and at least one installation parameter, and
automatic packaging of the standard software into an automatically distributable software package on the computer (3), as based on the packaging data transmitted by the server (1).

2. Process according to claim 1, wherein
an inquiry dialogue regarding the installation parameter automatically takes place on the computer (3).

3. Process according to claim 1, wherein
an inquiry dialogue automatically takes place on the computer (3) regarding the designation of the standard software.

4. Process according to claim 1, wherein
the designation of the standard software made available to the computer (3) is automatically recorded.

5. Process according to claim 1, wherein
the standard software is provided on the computer (3) itself, ideally on a removable data medium (4).

6. Process according to claim 1, wherein
the standard software is provided online over the communication network (2).

7. Process according to claim 6, wherein
the standard software is provided by the server (1).

8. Process according to claim 1, wherein
the communication network (2) employed is the Internet.

9. Process according to claim 1, wherein
the automatic transmission to the computer (3) of the packaging data stored on the server (1) and/or the automatic packaging of the standard software into an automatically distributable software package on the computer (3) is performed by means of a procedure executed on the computer (3).

10. Process according to claim 9, wherein
the procedure is made available by the server (1) and ideally is transmitted over the communication network (2).

11. Process according to claim 1, wherein
the installation parameter is stored on the server (1).

12. Process according to claim 1, wherein
the automatic packaging of the standard software into an automatically distributable software package is performed in a predetermined format, such that, when a standard software is not present in this predetermined format, an automatic conversion into this format is performed during packaging.
